(19) United States
(12) Patent Application Publication
(10) Pub. No.: US 2004/0114510 A1
(43) Pub. Date: Jun. 17, 2004

(54) Remote terminal multiplexer/de-multiplexer having protection bus

(76) Inventors: Frank W. Miller, Baltimore, MD (US); Winston Maxon Gadsby, Oak Hill, VA (US)

Correspondence Address: Stephen R. Whitt, 1215 Tottenham Court, Reston, VA, 20194, US

(21) Appl. No.: 10/319,678

(22) Filed: Dec. 16, 2002

(51) Int. Cl. G06F 11/00

(52) U.S. Cl. 370/217; 714/4

(57) ABSTRACT

A information signal multiplexer/de-multiplexer having application in environmentally uncontrolled remote terminals is described with line interface card redundancy capability.

### BACKGROUND OF THE INVENTION

1. Field of the Invention

The present invention relates generally to the field of telecommunications and, more specifically to a redundancy-protected signal multiplexer, and a method for protectively rerouting telecommunication signals in remote terminal equipment.

2. Discussion of the Prior Art

The conventional technology germane to an explanation of the present invention that follows is conceptually illustrated in FIG. 1. Within FIG. 1, selected telecommunications network components are shown interconnected across three environments. The physical environments in which these components operate are variously defined by multiple, published standards. Here, we generalize a multiplicity of environments into residence/business, connection, and central office environments.

The central office is a very controlled environment. Ventilation and heating/cooling systems maintain temperature and humidity within well-defined limits.

Pre-conditioned and/or back-up power are generally available, and more often than not a technician is available on a daily basis to trouble-shoot equipment problems. While the “central office” is a well-recognized, specific facility within the existing telecommunications infrastructure, the term “central office environment” (or central office-“like” environment) used herein more generally refers to any commercial facility housing telecommunications equipment in an environmentally stabilized manner. As one example, Telcordia standard GR-63 specifies a central office environment temperature range of normally from +5° to +40° C., with possible short-duration variations in a range of from −5° to +50° C. Relative humidity is specified by this standard in a range of 5 to 85%, with possible short-duration variations up to 90%. While not professionally maintained at the level of a central office, the residence/business environment is not subject to extreme swings in temperature and humidity. That is, an equipment vendor may readily assume certain reasonable limits in the environment found within a home or business.

The uncontrolled connection environment exists between the residence/business environment and the central office environment. Equipment residing in the connection environment must reliably operate in temperature extremes ranging from, for example, −40° to +65° C. Equipment failures in the connection environment are expensive, typically requiring that a technician be dispatched to a remote, or field equipment site.

An end user in the residence/business environment connects one or more telephone sets and/or computer modems to a wall jack. The wall jack is connected via twisted copper wire to a Subscriber Access Interface (SAI). The SAI takes many physical forms and may connect multiple residences in a neighborhood or multiple users from a commercial building, or a commercial office complex. Functionally, the SAI simply allows a user to be connected and disconnected from the Public Switched Telephone Network (PSTN).

An SAI is often, but not necessarily, connected to a Digital Loop Carrier (DLC). The DLC bundles a number of individual phone line signals into a single multiplexed digital signal for local telecommunications traffic between a telephone central office and a business complex or residential service area. Typically, up to 24 analog voice calls are combined into a single signal and transmitted over a single copper T-carrier system or E-carrier line, an optical fiber, or a wireless connection. In a home, business, or other installation using digital loop carrier, the analog phone lines of individual users are connected to a local DLC box which then converts the analog signals into digital form and combines (multiplexes) them into one signal communicated to the central office over a single line. At the central office, the combined signal is separated back into its constituent components.

Digital loop carrier can carry traffic from regular phone calls (Plain Old Telephone Service or POTS) and Integrated Services Digital Network (ISDN) service.

More recently, approaches have been developed for using DLC to handle the higher bandwidth of Digital Subscriber Line (DSL) service.

DSL is a conventional technology for bringing high-bandwidth information to homes and small businesses over existing copper telephone lines. DSL is expected to replace ISDN in many areas and to compete with cable modem technology in bringing multimedia products to homes and small businesses.

Assuming a home or small business is close enough to a central office offering DSL service, a user may receive up to 8 million bits of data per second (“bps”), thus enabling continuous reception of full-motion video, audio, and even 3-D effects. More typically, individual users provide from 512 Kbps to 1.544 Mbps downstream and 128 Kbps upstream. A DSL line can carry both data and voice signals simultaneously and the data part of the line may remain continuously connected. Thus, DSL service offers individual users a remarkably expanded set of entertainment and communications options. It remedies to a great extent the bandwidth bottleneck inherent in the analog transmission path between the home/business and the central office.

Returning to FIG. 1 and assuming DSL service between a user and the central office, the voice and data portions of the DSL signal are typically split somewhere along the connection path. Most contemporary DSL technologies require that a signal splitter be installed at the home/business. In any event, the voice path between the DLC or SAI and the central office connects the voice portion of the DSL signal (“the voice signal”) to a Class 5 switch. The Class 5 switch connects the voice signal to the PSTN.

The data portion of the DSL signal (“the data signal”) is acquired at the SAI and applied to a piece of equipment commonly referred to as Digital Subscriber Line Access Muliplexer (DSLAM). The conventional DSLAM is a network device located at a central office that receives signals from multiple DSL connections and puts the signals on a high-speed backbone line using various multiplexing technologies.

The “backbone” is a generic term referring to a larger transmission line that carries data gathered from smaller interconnected lines. At the local level, a backbone is a line or set of lines that local area networks connect to in order to form a wide area network connection or within a local are network to span distances efficiently (i.e., between buildings). On the Internet or wide area network, a backbone is a set of paths that local or regional networks connect to in order to form long-distance connections.

Depending on the specific product, a DSLAM multiplexes and connects a plurality of DSL lines with some combination of asynchronous transfer mode (ATM), frame relay, or Internet Protocol (IP) networks. In effect, the DSLAM allows a service provider to connect the fastest phone line technology, DSL, with the fastest backbone network technology, ATM.

Unfortunately, the promise offered by DSL service is limited to users living in relatively close proximity to a central office. Many factors affect the actual distance over which a DSL signal may be successfully transmitted. However, it is generally accepted that DSL signals can be transmitted over a maximum range, without a repeater, of about 5.5 kms (18,000 feet). Simply stated, as distance from the central office increases, the DSL data rate decreases.

Line interface cards are widely used in telecommunications equipment. Their easy replace-ability and modular design facilitate maintenance and provide cost-effective scalability. One advantage offered by conventional line cards is redundancy. As can be seen, for example, in U.S. Pat. No. 5,590,569 one or more redundant line cards may be provided in a plurality of line cards connected to a information signal bus. Upon detecting a line card failure, an associated Input/Output (I/O) circuit switches information signals from the failed line card to a redundant (backup) line card via a protection bus. Generally speaking, line card redundancy is accomplished with the added overhead of coherent I/O circuit control and an internal “protection bus.”

### SUMMARY OF THE INVENTION

The present invention provides an information signal multiplexer/de-multiplexer having one or more line interface card(s) adapted to receive a plurality of information signals and multiplex the information signals into a transmission information signal, and a packet interface card adapted to receive the transmission information signal from the line interface card and communicate the transmission information signal via an IP Network.

In one aspect of the present invention, a main bus connects the line interface card with the packet interface card while the multiplexer/de-multiplexer operates normally, Normal operation is determined by a control unit that monitors and controls operation of the line interface card(s) and the packet interface card(s). Further, at least one redundant line interface card is connected to the line interface card via a protection bus path. The information signals are switched from the line interface card to the redundant interface card upon detection of a failure condition by the control unit.

Moreover, in another aspect, the multiplexer/de-multiplexer according to the present invention is adapted for use at a remote terminal. Therefore, the circuitry forming the line interface card, the packet interface card, and the control unit are environmentally hardened to reliably operate over a temperature range of from −40° to +65° C. and/or a humidity range of from 0 to 90% (non-condensing).

Failure conditions may include loss of power, or the absence of a watchdog signal, as detected by the control unit.

In a related aspect, the present invention provides a control method for an information signal multiplexer/de-multiplexer of the type described above. Generally, the method includes the steps of monitoring failure conditions within the multiplexer/de-multiplexer, and normally processing the plurality of information signals in the line interface card until detecting a failure condition. However, upon detecting a failure condition, a failure signal is communicated to a logic circuit preferably located on the line interface card. In response to the failure signal, the line interface card seizes control of a protection and actuates a switching circuit to communicate the information signals to the redundant line interface card via the protection bus.

### BRIEF DESCRIPTION OF THE FIGURES

For a more complete understanding of the present invention and the associated advantages, reference is now made to the following brief description, taken in connection with the accompanying drawings and detailed description, wherein like reference numerals represent like elements, in which:

FIG. 1 is conceptual overview of a conventional telecommunications systems;

FIG. 2 is conceptual overview of a telecommunication system in accordance with the present invention;

FIG. 3 is a block diagram of a multiplexer/de-multiplexer having information signal processing redundancy in accordance with the present invention;

FIG. 4 is an exemplary logic circuit adapted to switch for use in a multiplexer/de-multiplexer designed in accordance with the dictates of the present invention; and,

FIG. 5 is a flowchart illustrating an exemplary control method in accordance with the present invention.

### DETAILED DESCRIPTION OF PREFERRED EMBODIMENT(S)

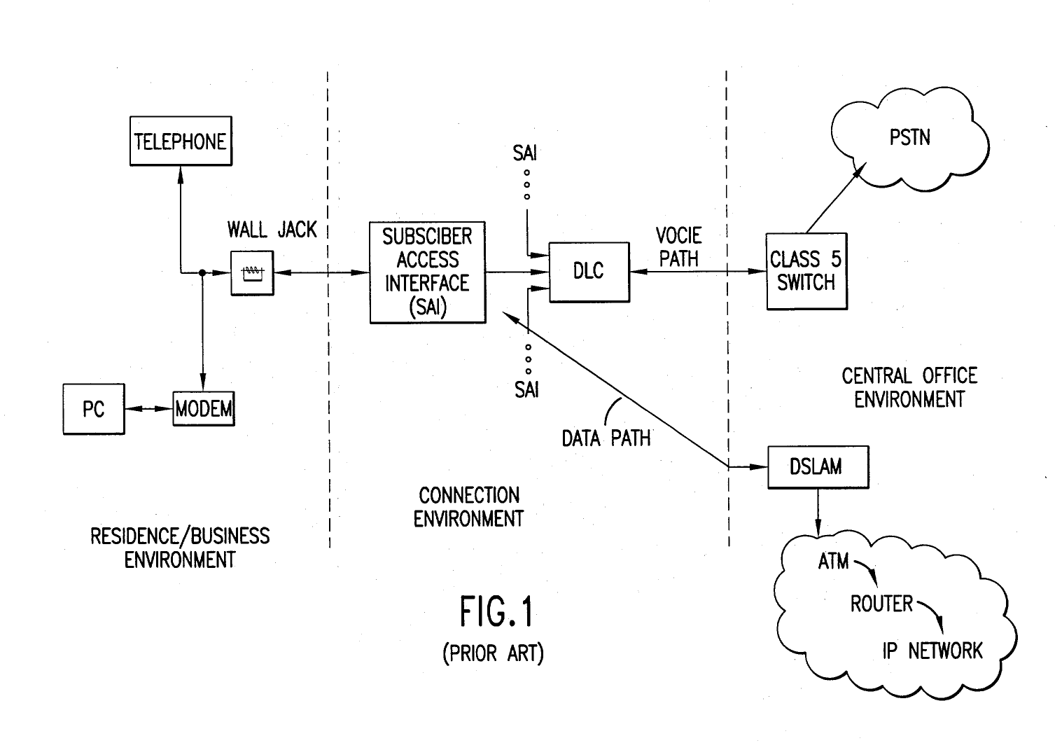

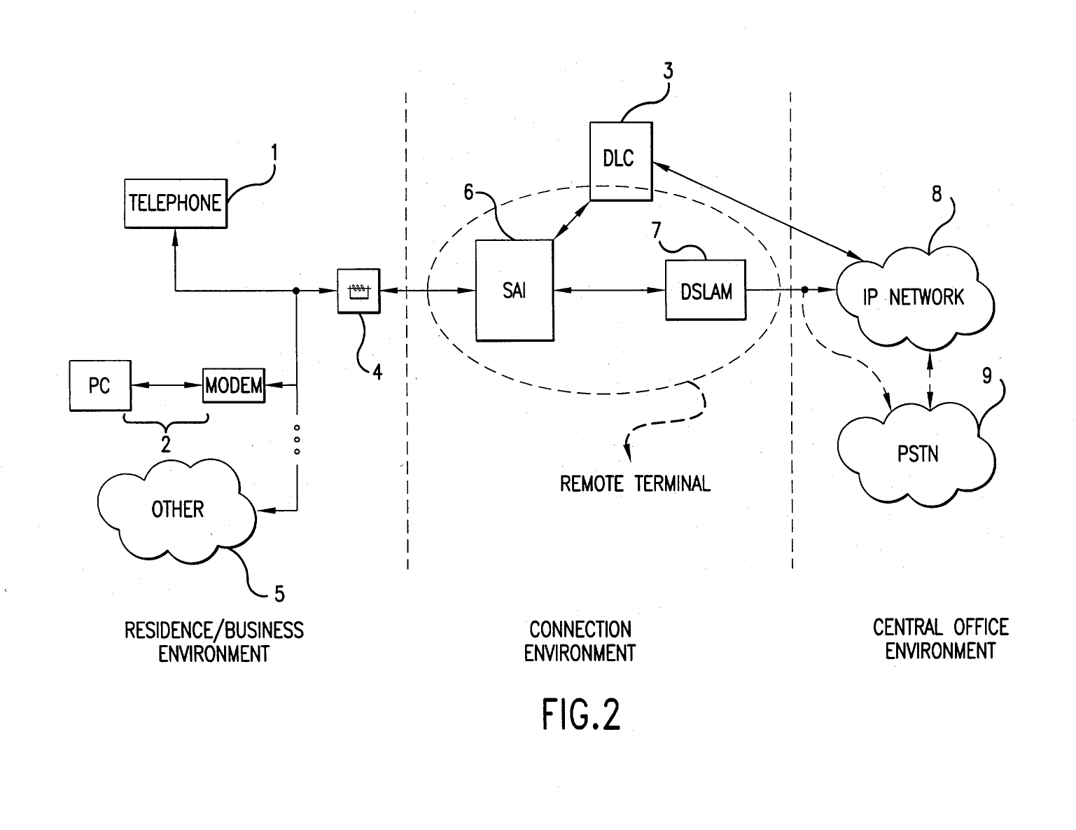

The present invention may first be conceptually considered in the context of FIG. 2, as compared with the conceptual illustration of the conventional approach already given in relation to FIG. 1. Within FIG. 2, a residence/business environment contains end user equipment such as a telephone 1, personal computer (PC) and modem combination 2, and other equipment 5, such as a television set, digital recorder, system server, local area network, etc., connected to a point at which telecommunications services are physically provided, here as an example, wall jack 4.

In the working example that follows, it is assumed that DSL service is being provided to the end user. However, this is just a contemporary example. The present invention is not limited in its application to only DSL signals and DSLAMs associated with DSL service. Any “information signal” and associated “information signal multiplexer” may be implemented in accordance with the percepts of the present invention.

Returning to the example shown in FIG. 2, wall jack 4 is physically connected to a conventional Subscriber Access Interface (SAI) 6. SAI 6 may take many physical forms but functionally connects one or more copper line pairs to the Public Switched Telephone Network (PSTN) 9, in conjunction with a Digital Loop Carrier (DLC) 3. As noted in relation to the conventional system, SAI 6 usually resides in the outside plant or connection environment and is subject to a full range of environmental conditions. According to the dictates of the present invention, the information signal multiplexer, or DSLAM, is also located at a remote terminal in the connection environment.

Moving the DSLAM from a central office environment to a remote terminal allows for a dramatic reduction in the DSL signal transmission distance between the DSLAM and the end user. A “remote terminal” is any network element site in a telecommunications network residing between the central office environment and the residence/business environment. The central office environment includes not only actual “Central Office (CO)” sites, but also includes closed environmental vaults (CEVs) and similar, environmentally regulated equipment sites.

Placing DSLAM 7, the information signal multiplexer, in remote terminal locations represents a sharp departure from the conventional practice, and requires the DSLAM to be environmentally hardened to withstand the extremes of the unregulated connection environment. As will be seen hereafter, removal of the DSLAM from the central office environment to a remote terminal also necessitates changes to the architectural design of DSLAM 7.

In the example, DSLAM 7 connects multiple DSL signals from a number of end users with IP Network 8 and PSTN 9 using conventionally understood signal processing/connection techniques. That is, one or more conventional multiplexing/de-multiplexing techniques may be used to combine and separate individual DSL signals within DSLAM 7.

Equipment located at remote terminals has historically been very low density and relatively “dumb,” that is, simple in functionality. Conventional remote terminal equipment might connect four (4) end users via a single line card. In this low density configuration, the loss of a single line card would have a minimal impact on a service provider since a relatively small number of end users are inconvenienced. In other words, the service loss caused by a single line card failure would probably not require an immediate service call to the site of the line card failure.

Unlike conventional connection environment equipment, however, DSLAMs are by their very nature relatively high density devices. This is particularly true for multi-service DSLAMs (or multi-service information signal multiplexers). At present, there are three main DSL service types—asymmetric DSL (ADSL), symmetrical DSL (SDSL), and integrated services digital network (IDSL) each enabled by different applications and serving differentiated markets.

ADSL is well adapted to the needs of mass market, residential users. Its asymmetry is ideal for typical residential use of the World Wide Web. Full-rate ADSL provides roughly 8 Mbps downstream (to the user) and 0.64 Mbps upstream (to the service provider). As a result of its mass market appeal, low price, and hence, and its ability to counter the cable-modem market alternative, ADSL is expected to take the largest share of the current DSL varieties.

While ADSL is likely to be the most attractive option for casual Internet users, SDSL is the most popular with businesses. SDSL meets the requirements of this market segment because symmetric bandwidth up to 1.5 Mbps mimics LAN connectivity. This enables workers to send and receive large files from corporate servers with high speed in both directions.

IDSL serves a unique market segment as a result of its greater reach, albeit with decided performance tradeoffs. Typically, IDSL speeds are 128 to 144 Kbps. This technology has been developed for customers “too far” from a Central Office to receive ADSL or SDSL, as well as customers wanting to preserve their existing ISDN service. Clearly, the present invention will tend to obviate IDSL service, but the existing customer base must be accounted for in any multi-service DSLAM design.

In order to offer a menu of DSL services cost effectively, service providers must deploy ADSL, SDSL, and IDSL from a single integrated DSLAM platform. Setting aside the existing DSL signal types for the moment, service providers will, no doubt, be confronted with an ever increasing diversity of information signal types as broadband telecommunication services are provided to residential and small business customers. Emerging information signal multiplexers must therefore become higher density devices while at the same time making the physical move from a central office environment to remote terminals in the connection environment in order to expand the reach of the constituent services.

Without the ability to handle a full set of evolving information signals, a service provider will be forced to deploy only a limited information signal multiplexer and ignore some market segments, or serve the whole market by deploying multiple information signal multiplexers from different vendors. The present invention preferably provides a multi-service, information signal multiplexer, for example a broadband-access network element that combines support for multiple DSL transmission types.

When coupled with high-capacity, IP routing, the present invention provides scalability, port density, and a redundant architecture for reliability. A multi-service DSLAM located at a remote terminal enables relatively efficient deployment of broadband networks for high-speed Internet access as well as voice and video applications. A DSLAM configured according to the present invention may also allow full ATM switching, traffic management, and quality of service, in addition to the delivery of a full set of DSL services. A multi-service DSLAM can also be configured to add value in the form of routing and security functionality, while optimizing the bandwidth of existing infrastructure, and delivering high-speed integrated services over a single-access medium.

The present invention preferably provides a versatile DSLAM that may be variously configured to optimize remoteablity. “Remoteability” is the ability to deploy the minimum amount of technology required to support present demand in a given market segment, and thereafter scale-up the equipment as demand increases. Such an ability allows a lower breakeven point for market entry and economical growth as increased demand warrants. The present invention provides for a variable number of replaceable lines cards within a single housing. Individual line cards may be configured to handle any reasonable number of users, but 32 line inputs are presently preferred on a single line card.

In sum, the cost effective extension of DSL service necessarily drives DSLAM provisioning from COs and CEVs into remote terminals. Trunking, scalability and remoteability considerations drive DSLAM designs into high density capabilities. Such high density configurations require effective redundancy features, since an uncorrected loss of service to 32 customers, for example, would require an immediate service response (i.e., a service technician call) to the remote terminal housing a faulty line card. Clearly, DSLAMs having high density line cards and being located in remote terminal environment require some form of information signal processing redundancy.

The use of replaceable line cards to receive and/or transmit information signals is well known. Further, the concept of line card redundancy is also well known. However, line card redundancy is rarely a feature included in equipment resident at a central office. That is, the stable operating environment of the central office environment, the availability of back-up equipment, and relative availability of service personnel generally obviate the expense of full line card redundancy. Historically, this has been the case for DSLAM located in central office environments.

Before continuing, it should be noted that conventional voice switches do include complex circuitry for protecting voice calls, as required by government regulations. However, no equivalent regulation exist for the data portion of the information signal. Thus, when a conventional equipment failure impacts the data portion of an end user's service, his/her connection is simply dropped until the failure is remedied. Where such a remedy takes place in a central office environment, it normally occurs in an acceptable timeframe. However, recognizing the possibility of a high-density line card failure in a information signal multiplexer located at a remote terminal results in the need for an efficient data signal protection scheme, i.e., line card redundancy.

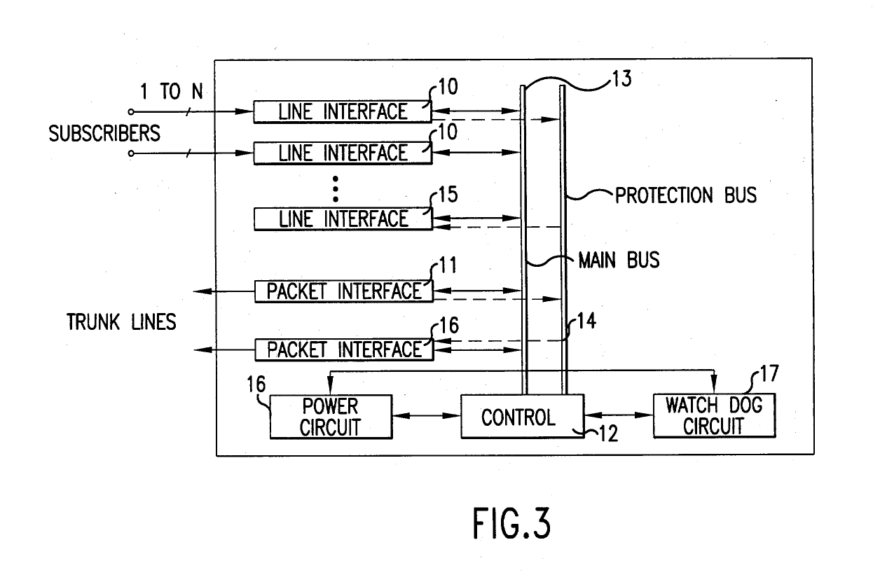

The present invention accordingly provides an information signal multiplexer capable of receiving a variety of information signals ranging, for example, from DS0 to T1, and preferably including DSL signals. With reference to FIG. 3, multiple subscriber lines terminate in a plurality of line interface cards 10. Each line card 10 may terminate from 1 to n subscriber lines of similar information signal type. Each line card 10 is connected to a high-speed, main bus 13. Main bus 13 also connects one or more packet interface cards T1. Each packet interface card 11 is connected to a trunk line that communicates multiple subscriber information signals to the IP network and the PSTN, typically through a central office facility.

Line interface card 10 and packet interface card 11, as well as main bus data transport, are functionally controlled by a microprocessor, digital logic circuit, or similar “control unit” 12. When a line interface card failure is detected, control unit 12 causes all subscriber information signals normally processed by the failed line card to be switched from main bus 13 onto a protection bus 14. Like, main bus 13, protection bus 14 is a high-speed data path, preferably implementing an IP/MPLS—like backbone.

Information signals normally connected to a failed line interface card are switched via protection bus 14 from the failed line interface card to a redundant line interface card 15. Redundant line interface card 15 thereafter processes the information signals in conventional fashion and communicates with one or more packet line interface card(s) 11 via main bus 13 under the direction of control unit 12.

The illustrated distinction between main bus 13 and protection bus 14 is entirely conceptual. Those of ordinary skill in the art will recognize that physical (i.e., layout and/or routing) transmission line separation is not the point illustrated in FIG. 3. Rather, any number of “by-pass” arrangements may be physically implemented to facilitate an alternate information signal connection path around or through a failed line card. For example, a sequence of end user connection ports within the remote terminal multiplexer/de-multiplexer may function as a protection bus. In this example, the protected signal lines are Tip and Ring leads, or the subscriber interface itself. Alternately, the information signal may be “picked-up” at some other point on the line interface card.

Thus, “main bus” refers to an electrical path normally traversed by an information signal through the multiplexer/de-multiplexer when a line interface card associated with the information signal is operational. “Protection bus” refers to an alternate electrical path traversed by the information signal through the multiplexer/de-multiplexer when the line interface card associated with the information signal has malfunctioned. The physical layout, connection, interface, and constitution of these two alternate electrical paths is, however, a matter of individual design choice.

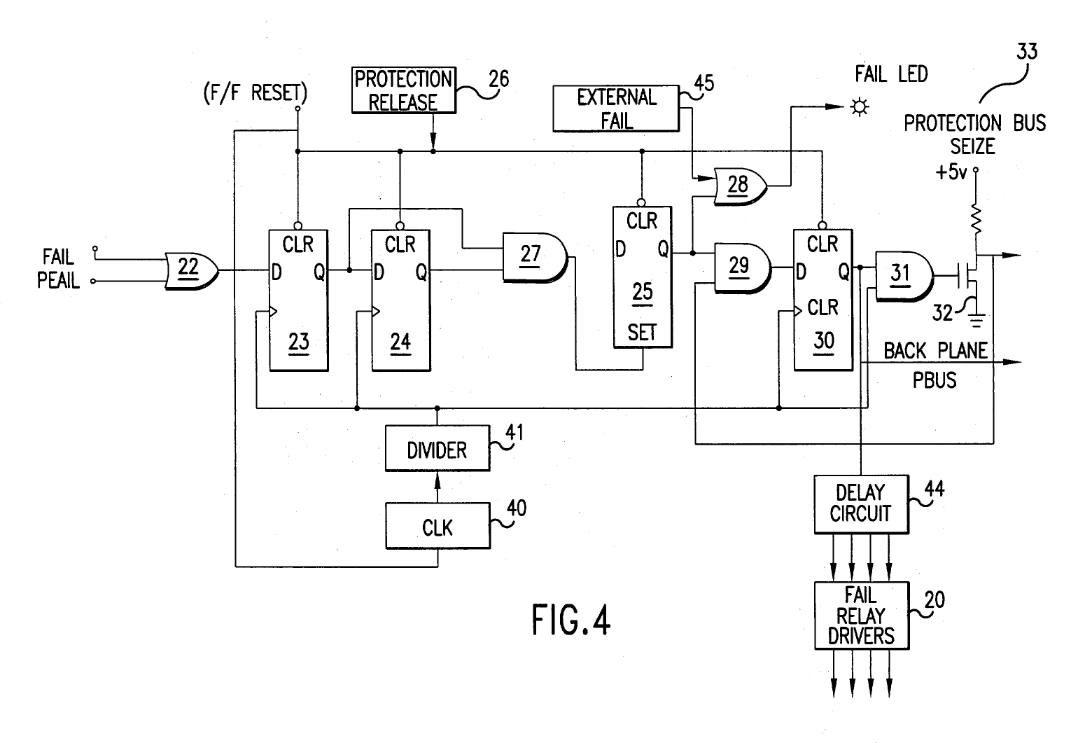

FIG. 4 illustrates one possible circuit adapted of switch information signals from a failed line interface card onto a redundant line interface card via a protection bus. However, unlike conventional redundancy techniques no separate I/O circuit is required to transfer (i.e., switch) information signals from a failed line card to a backup line card. In contrast, the failed line card essentially passes the information signals directly to the protection bus, as opposed to the main bus, by means of a simple relay circuit actuated by a logic circuit of the type shown in FIG. 4. Thus, the present invention greatly reduces the complexity normally associated with conventional, redundant line card architectures.

The exemplary circuit shown in FIG. 4 illustrates protection bus operation. As a first requirement, the protection bus circuit monitors line card hardware and autonomously activates protection (fail) relay drivers 20 on the line interface card in response to a failure detection. Actuation of the fail relay drivers 20 switches all lines, each signal “line” being associated with a end user information signal, on the now failed line interface card onto corresponding lines on a redundant line interface card via the protection bus.

As presently preferred, protection circuit logic is implemented using 5 Volt Programmable Logic Device (PLD). The power supply for the PLD may be derived from a backplane supply and/or a separate internal 5 Volt supply. Schottky diodes can be used to route power to the PLD supply pin from one of two separate supplies, if more than one supply exists for redundancy purposes.

A separate watchdog circuit 17, (see, FIG. 3), may be used to monitor the state of control unit 12 and/or the condition of line card power circuit 18. A Xicor X4043 has been successfully used as a watchdog circuit in one embodiment of the present invention. In a presently preferred control method, control unit 12 periodically (e.g., 1.4 seconds) strobes watchdog circuit 17. Absent this strobe signal, the watchdog circuit will time out and generate a FAIL signal applied to OR gate 22 in FIG. 4. Alternately, should watchdog circuit 17 detect a power (P) failure (e.g., detection of less than 2.7 Volts on a selected 3.3 Volt power line), a separate PFAIL signal is applied to OR gate 22. Naturally, many alternative “failure conditions” might be defined to indicate a non-normal operating condition(s) for the line interface card, power circuits, and/or the control unit 12.

In the presence of FAIL or PFAIL, first flip-flop 23 and second flip-flop 24 are set following an appropriate debounce (delay) time (e.g., 1 second). If the failure signal persists through the debounce period, third flip-flop 25 is set. Once set, third flip-flop 25 can only be reset by application of a release protection signal 26 from control unit 12. Thus, following failure signal debounce, the line interface card failure condition is latched into the protection bus circuit to preclude fail state/pass state toggling caused by an intermittent failure. In other words, a properly functioning line card will operate normal mode via the main bus, while a failed line card or an intermittent line card will operate in failure mode passing information signals to a redundant line card via the protection bus.

More particularly, a failure signal sets first and second flip-flops 23 and 24 causing a true condition at the output of AND gate 27 which sets third flip-flop 25. Third flip-flop 25 latches the fail state condition into the circuit. The output of third-flip-flop 25 is applied to OR gate 28 which may also receive a external fail signal indicating some other fail state condition (or safety condition) in the system. The output of OR gate 28 drives a fail state indicator, here an LED on the front panel of the multiplexer/demuliplexer.

The release protection signal 26 is preferably activated when control unit 12 successfully writes to a mask register and only thereafter toggles a release protection bit or otherwise generates an affirmative release protection signal. This interlock mechanism is preferred to ensure that control unit 12 does not accidentally release protection in the event a failed control unit 12 begins executing random control code.

The output of third flip-flop 25 is filtered through a protection bus contention circuit. In the exemplary circuit shown in FIG. 4, the bus contention circuit consists of fourth flip-flop 30, AND gates 29 and 31, and backplane drive transistor 32. The bus contention circuit allows arbitration as between multiple line interface cards connected to the common backplane and requesting simultaneous use of the protection bus.

A backplane SEIZE signal is routed to all line interface cards in the multiplexer/demultiplexer system to arbitrate simultaneous protection bus requests. In a presently preferred embodiment of the bus contention circuit, a 1 Hz contention clock signal is applied to an input of AND gate 29. The contention clock signal may be conventionally rendered from a master clock (CLK) signal originating from high frequency clock oscillator 40 and divider circuit 41 by means of well known resistor/capacitor (RC) circuits. The use of relatively loose tolerance RC elements is intentional, since the resulting variances in the contention clock signal for each line card is desirable should two line cards attempt to seize the protection bus at exactly the same moment.

The contention clock signal goes LOW for a very short interval as compared with it period. This brief LOW input causes AND gate 29 to go reset (or not-true) during the period, thereby locking out the line card's request to seize the protection bus. That is, the output of AND gate 31 normally drives the protection bus drive transistor 32 to seize one line of the protection bus when the protection bus circuit is in fail state. (Those of ordinary skill in the art will recognize that a plurality of drive transistors are similarly driven, however only a single drive transistor is shown herein for the sake of clarity). However, the resulting protection bus seizure is interrupted (or released) during a brief period during each second, the brief period being defined by the period of the contention clock. During this release period, control unit 12 may monitor the seize line for an indication of seizure from other units to determine a simultaneous protection bus seizure request.

If a second line card is simultaneously requesting the protection bus, the drive transistor signal remains LOW even during the period when the bus request is temporarily locked out locally. When this happens, fourth (or contention) flip-flop 30 clocks data based on the output of AND gate 29 as determined by the read bus (drive transistor 32 output) and the bus request signal from third flip-flop 25. Upon sensing a second line card's bus request during the lock out interval, control unit 12 may override the first line card bus request, keeping the output of corresponding contention flip-flop 30 LOW, thereby preventing the first line card from holding the protection bus. Alternatively, control unit intervention is unnecessary, and the bus request is automatically locked out. The first (or subsequent) line card is thereafter locked out of protection bus use until the second line card releases the protection bus by allowing the protection bus SEIZE signal 33 to go high again. The protection bus SEIZE signal 33 is communicated to Packet Interface Card 11 (in FIG. 3), and indicates that the unit has successfully arbitrated control of the protection bus. The output of drive transistor 32 is the protection bus SEIZE signal 33 which is common to line interface cards.

The output of fourth flip-flop 30 (i.e., the gated bus request) is used to drive the protection (fail) relay circuit 20, preferably through a delay circuit 44. This happens only after the protection bus circuit is successful in seizing the protection bus. Otherwise, in the absence of protection bus seizure, the protection (fail) relay drivers are released.

Once a first line card has successfully seized the protection bus, it will relinquish control of the bus when, for example, (1) a second line card is sensed on the protection bus, (2) upon activation of the release protection signal 26 by control unit 12 through a masked interlock, or (3) upon power cycling, i.e., by a new power ON reset operation.

Normally, all line card failures require some form of external fail state indication. The example given in FIG. 4 is an LED viewable by a service technician. This visual indicator allows ready identification of the faulty line card amongst a plurality of similar line cards in a rack or housing. It is advantageous to combine other fail state signals to drive the external indicator. Similarly, fail state indications may be sent to a telecommunication administrator, a packet controller, etc.

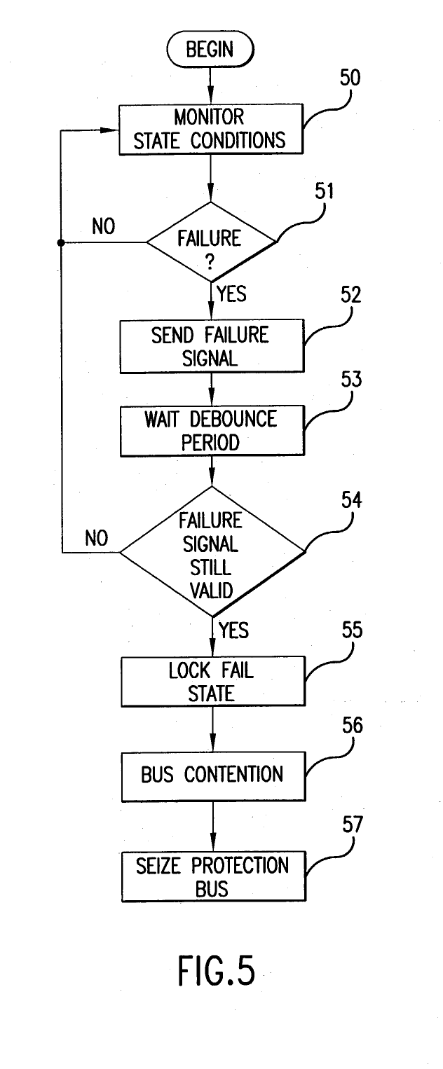

Functional aspects of the exemplary circuit given in FIG. 4 characterize a control method by which a line card failure in a multiplexer/demultiplexer will result in seizure of a provided protection bus. This control method is further illustrated in the flowchart shown in FIG. 5.

In a first step (50), pre-determined state conditions, such as minimum operating voltage and/or an affirmative indication of control unit operation, are monitored. In the event of a line card failure (step 51=yes), a failure signal is sent to a protection bus circuit (52). Following a debounce delay (53), and continued validity of the failure signal (step 54=yes), the protection bus enters a locked fail state (55). A bus contention decision is made (56) and the protection bus is seized (57).

The foregoing protection bus circuit and the associated control method are merely examples of numerous hardware and software implementations that will allow effective line card redundancy in a information signal multiplexer/demultiplexer according to the present invention. This telecommunications network element has been referred to as a “line access gateway.” In its most basic functionality, it receives information signals form multiple users multiplexes these signals into a form more suitable for efficient communication via the IP Network (cloud) to access the PSTN and/or the Internet, and performs the reverse de-multiplexing procedure.

Yet, while performing many conventional functions and implementing analogous features, the line access gateway converges a Digital Loop Carrier (DLC), a Digital Subscriber Line Access Multiplexer (DSLAM), and even some aspects of a Class 5. Switch. Such convergence takes place in a single device located in the connection environment. Such a location seriously decreases the transport span for distance sensitive information signals such as DSL signals. Thus, services are expanded far beyond the traditional bounds established around central office facilities.

As noted, the line access gateway of the present invention is not limited to the exemplary information signals discussed above. Nor is the protection bus switching circuit and control method limited to the specific embodiment described. Rather, those of ordinary skill in the art will readily understand that modifications and adaptations of the design and control principles explained herein will be necessary for particular multiplexer/de-multiplexer designs.

What is claimed is:

1. An information signal multiplexer/de-multiplexer, comprising:
a line interface card adapted to receive a plurality of information signals and multiplex the plurality of information signals into a transmission information signal;
a packet interface card adapted to receive the transmission information signal from the line interface card and communicate the transmission information signal via an IP Network;
a main bus connecting the line interface card with the packet interface card;
a control unit monitoring and controlling operation of the line interface card and the packet interface card;
a redundant line interface card connected to the line interface card, wherein the plurality of information signals is switched from the line interface card to the redundant interface card upon detecting a failure condition;
wherein circuitry forming the line interface card, the packet interface card, and the control unit are environmentally hardened to reliably operate over a temperature range of from −40° to +65° C.

2. The multiplexer/de-multiplexer of claim 1, wherein the line interface card and the redundant line interface card are adapted to receive up to 32 information signals; and
wherein the information signals comprises at least one information signal selected from a group of information signals types consisting of; DSO, DS3, T1, E1, and DSL

3. The multiplexer/de-multiplexer of claim 1, further comprising:
a protection bus connecting the line interface card and the redundant line interface card.

4. The multiplexer/de-multiplexer of claim 3, wherein the line interface card further comprises:
a logic circuit receiving a failure signal upon detection of a failure condition and generating relay drive signal; and,
a relay driver switching the plurality of information signals from the main bus to the protection bus in response to the relay drive signal.

5. The multiplexer/de-multiplexer of claim 4, wherein the logic circuit comprises a protection bus contention circuit.

6. The multiplexer/de-multiplexer of claim 4, further comprising:
power circuitry supply power to the control unit; and
a watchdog circuit receiving a periodic strobe signal from the control during normal operation.

7. The mutliplexer/de-multiplexer of claim 6, wherein the watch dog circuit generates the failure signal upon timing out in the absence of the periodic strobe signal.

8. The mutliplexer/de-multiplexer of claim 6, wherein he watch dog circuit generates the failure signal upon detecting a low voltage condition in the power circuitry.

9. The mutliplexer/de-multiplexer of claim 4, further comprising a debounce circuit delaying actuation of the logic circuit for a delay period following receipt of the failure signal.

10. The mutliplexer/de-multiplexer of claim 9, wherein the logic circuit further comprises:
circuitry latching a logic state indicative of the failure condition within the logic circuit following continuation of the failure signal through the delay period.

11. The mutliplexer/de-multiplexer of claim 10, wherein the latching circuitry may be de-latched upon receipt of a protection release signal from the control unit or upon a power cycling of the mutliplexer/de-multiplexer.

12. The multiplexer/de-multiplexer of claim 1, wherein the circuitry forming the line interface card, the packet interface card, and the control unit are environmentally hardened to reliably operate over a non-condensing humidity range of from 0 to 90%.

13. A control method for an information signal mutliplexer/de-multiplexer, wherein the mutliplexer/de-multiplexer comprises a control unit, line interface card receiving a plurality of information signals, and a redundant line interface card connected to the line interface card via a protection bus, the method comprising:
monitoring failure conditions;
processing the plurality of information signals in the line interface card until detecting a failure condition;
upon detecting a failure condition, communicating a failure signal to a logic circuit on the line interface card;
seizing control of the protection bus in response to the failure signal;
actuating a switching circuit on the line interface card to communicate the plurality of information signals to the redundant line interface card via the protection bus.

14. The control method of claim 13, further comprising:
before seizing control of the protection bus, debouncing the failure signal for a delay period; and,
upon continuation of the failure signal throughout the delay period, setting a logic state within the logic circuit indicative of the failure condition.

15. The control method of claim 14, further comprising:
re-setting the logic state within the logic circuit indicative of the failure condition upon receiving a protection release signal for the control unit.

16. The control method of claim 14, further comprising:
re-setting the logic state within the logic circuit indicative of the failure condition upon cycling through a power re-start for the multiplexer/de-multiplexer.
